(19) United States
(12) Patent Application Publication
(10) Pub. No.: US 2002/0079690 A1
(43) Pub. Date: Jun. 27, 2002

(54) Method and apparatus for recording, filing, and indexing abstracted material from recipes and recipe sources for ease of reference

(76) Inventor: Sandra Jean Forbes, Vienna, VA (US)

Correspondence Address: Sandra J. Forbes, 9941 Corsica Street, Vienna, VA, 22181, US

(21) Appl. No.: 09/981,809

(22) Filed: Oct. 19, 2001

Related U.S. Application Data
(63) Continuation of application No. 09/557,309, filed on Apr. 25, 2000, now abandoned.
(60) Provisional application No. 60/131,235, filed on Apr. 27, 1999.

(51) Int. Cl. B42F 21/00

(52) U.S. Cl. 283/36

(57) ABSTRACT

The present invention relates to a method and apparatus for recording, filing and indexing abstracted material from recipes and recipe sources consisting of an indexed loose leaf binder, an indexed storage box and a grocery planner pad relating to said box and binder. The present invention provides a way to organize and easily reference recipes from multiple sources in one central location in a reference binder through the use of a columnar format locator form contained within. Unlike prior art, abstracted material as well as sources are indexed according to the same food categories commonly used in food preparation. The menu planner portion of the grocery planner refers to the location of the recipes as found in the reference binder. Each ingredient is marked and defined on a list of grocery items preprinted and categorized on the grocery list portion of the grocery planner.

### CROSS REFERENCE TO RELATED APPLICATIONS

I claim the benefit of provisional application No. 60/131235 filed on Apr. 27, 1999.

### STATEMENT REGADING FEDERALLY SPONSORED RESEARCH AND DEVELOPMENT

Not Applicable

### REFERENCE TO MICROFICHE APPENDIX

Not Applicable

### BACKGROUND OF THE INVENTION

In the kitchen, cooks need an efficient way to file and reference all their recipes. Much time is wasted looking for any given recipe within a library of multiple cookbooks. Cooking nightly meals has given way to buying fast food or eating unbalanced meals due to lack of planning. It is common for cooks not to plan a menu for any given week and find themselves at the grocery store trying to plan for the upcoming days or week on the spot resulting in repetitive meals and a return to the store later on in the week for missing ingredients or supplies. This practice is usually more costly, wastes hours of time, and results in frustration. Meals become a chore instead of an opportunity to share time with family and friends. Those cooks that do plan ahead find themselves wasting time rewriting their grocery list and menu plans in the same format week after week. Past inventions have tried to address this problem but have resulted in cumbersome and lengthly recording requirements or confusing filing systems. Some systems have concentrated on calorie counting, or coupon organizing or are general filing systems and are not specifically geared toward the unique needs of menu planning and recipe organization. The few systems that are designed for menu planning require extensive rewriting of recipes to fit their system or they don't allow for the cook to customize the system to his/her individualized cooking habits and interests. Recipes are to be alphabetized by their title or are arbitrarily categorized by the current user with no reference to what those categories are for another user to refer to. Even if recipes are indexed in one source a separate page is required to record the reference information for each recipe requiring the user to go through many pages when trying to locate a recipe. This format is also inefficient when trying to menu plan. These systems do not have a standardization of reference headings between the reference book and the recipe box source when the heading is the only other helpful locating information other than the title of the recipe. Also these systems provide no way of recording a menu plan taking advantage of the referencing system. Other filing systems not designed for the unique requirements of recipe locating are ineffective because they are file folder based, preorganized and rely heavily on the need to subcategorize. They do not address the unique needs of a cook to reference recipes and to have the ability to customize the system.

This invention is directed to a method and apparatus for recording, filing and indexing abstracted material from recipes and recipe sources for ease of reference. It is customizable to suit any source and form of existing recipes. It can accommodate all existing loose-page recipes printed or hand written on cards and papers of most sizes, as well as favorite recipes found in the pages of any number of cookbooks. Recipes do not need to be rewritten. The combinations of any or all of the components: reference binder, storage box with dividers, and grocery planner in this invention can and will aid the cook in working efficiently in the kitchen and therefore saving both time, money, and frustration. The present invention gives the user an easy and convenient format for his/her grocery list and menu plans based on a simple and concise reference system.

### BRIEF SUMMARY OF THE INVENTION

The apparatus of the present invention includes three main parts. There are tab-indexed dividers or preprinted labels to be adhered to dividers to be used in a storage box, a tab-indexed reference binder, and a grocery planner. These three parts can function separately, but maximum benefit is achieved when used together. The storage box is where all existing loose recipes are filed and stored separated by a tab-indexed divider. The tab-indexed dividers are step indexed to allow for a number of headings to be viewed simultaneously. The tab indexed dividers for both the storage box and the reference binder include headings of food categories most often used in food preparation. The headings may be preprinted or the tabs may be blank allowing a user to input his own headings, thereby allowing for customization. The headings on the tab indexed dividers of the storage box or labels for the dividers of a storage box correspond to those on the tab indexed dividers of the reference binder for easy cross reference. Helpful cooking or marketing information may be printed on the body of the tab indexed dividers in the reference binder or the dividers for the storage box.

The present invention allows all of a user's recipes to be indexed and categorized in one convenient location. That is, the present invention provides a way to organize and easily reference all of a user's cookbooks, cooking magazines or loose recipes, etc. Thus when menu planning, a user would be able to reference one book and get a listing of the various recipes he/she has tried and chosen to index. Stated another way, a cook would be able to conveniently locate indexed recipes from multiple sources just by looking through one reference binder.

Locator forms are provided for use behind the appropriate tab indexed divider in the reference binder. Each form includes lines on which can be recorded the title, location and notes corresponding to the various recipes indexed. The reference binder provides a central location for the information pertaining to recipes from various sources, thereby allowing fast, easy retrieval of all the user's recipes including those found in the storage box or those found in various bound books, such as cookbooks or magazines. Many recipes can be recorded on each form thus making each form a convenient tickler file for the user when trying to plan menus. The reference binder is of a loose leaf, multiple page format which allows for a large collection of recipes to be indexed easily. The necessary data for each recipe may be recorded on one line on the form thus making the method easy to set up and maintain unlike previous methods. Although the pertinent data for each recipe may usually be recorded on one line of the form, more than one line may be used for any given recipe.

The reference binder also contains a master index form to list all cookbooks and recipe sources. Each master index form includes lines on which can be recorded the title of each source, an abbreviation code, (an option which may be used when recording recipes in the main section of the binder) and a storage location of the source. The master index forms can be subdivided alphabetically so that new sources may easily be added to the reference binder. All forms, tab indexed dividers and master index forms are hole punched and in loose leaf form to allow for customization and expansion of the reference binder to the user's needs.

Grocery planner forms are also provided. Each grocery planner form includes space to record one or more weeks of meals and may be preprinted with a grid. The location, i.e. storage box or particular cookbook as referenced in the reference binder of the recipes for each meal may be recorded in the grid thus making an easy reference for the user all throughout the week of meals planned. The user can be confident that all the ingredients and grocery items needed for that particular meal have been purchased. This will help cooks to eliminate last minute trips to the grocery store for missing ingredients or supplies or resorting to fast food or repetitive meals because of lack of planning. The practice of planning ahead will also save hours of time and frustration related to preparing nightly meals. The grocery planner forms may be stored in the reference binder for reference when making future menu plans. Because the reference binder provides an easy, convenient location for menu plans, the user is more likely to save his/her menu plans. By saving the menu plans, they can be used again in the future, thus saving the time of having to come up with a completely new menu plan.

The grocery planner also provides a listing of popular items in the categories commonly used by grocery stores to organize their aisles. The grocery planner form may be preprinted and/or include space for listing items not listed. Any item can be selected for purchase by checking the blank space in front of the item and detailed information written in the blank space provided following each item. Instead of checking the blank space in front of the item, a number can be written therein to indicate the quantity of items to be purchased. Further, the blank space in front of each item allows the user to indicate whether a coupon will be used with the purchase of the item or the item is on sale. The preprinted grocery planner is a big time saver for managers of busy households because it eliminates the need to rewrite grocery lists each time a user goes to the grocery store. It's magnetic backing allows it to be conveniently adhered to a refrigerator or other location in the kitchen and thus can be updated easily. The multiple sheet format allows the user to conveniently tear off the top page and take it to the grocery store with him/her and the next blank form is ready to be updated. Prior art required that the user use a multiple page format and have to clean or wipe off the surface between uses.

The storage box with dividers or labels, reference binder as well as the tab indexed dividers and forms may be customized to aid in the marketing of a specific product or group of products. Categories or subcategories could be added using the titles of a specific item being marketed. For instance, a company marketing a stir fry skillet could include a tab indexed divider having a heading “Stir Fry Skillet” for example to the reference binder and/or storage box dividers or labels for recording recipes that use a stir fry skillet, thus enhancing that product's marketing appeal. The apparatus and method of the present invention could also be used by a company desiring to index recipes from multiple books. A writer of a cookbook may also include recipes in the apparatus to market his/her cookbook.

### BRIEF DESCRIPTION OF THE THE DRAWINGS

FIG. 1 is a view of a locator form for use behind the appropriate tab indexed divider in the reference binder.

FIG. 2 is a view of a master index form to list all recipe sources.

FIG. 3 is a view of a grocery planner form where the names and locations of recipes chosen for future meals may be recorded and needed grocery items may be recorded.

FIG. 4 is a view of a tab indexed divider for the reference binder.

FIG. 5 is a view of a tab indexed divider for a storage box.

FIG. 6 is a three dimensional view of the storage box where loose recipes are filed and stored.

FIG. 7 is a view of the reference binder where the location of recipes and recipe sources and menu plans are indexed and recorded.

### DETAILED DESCRIPTION OF THE INVENTION

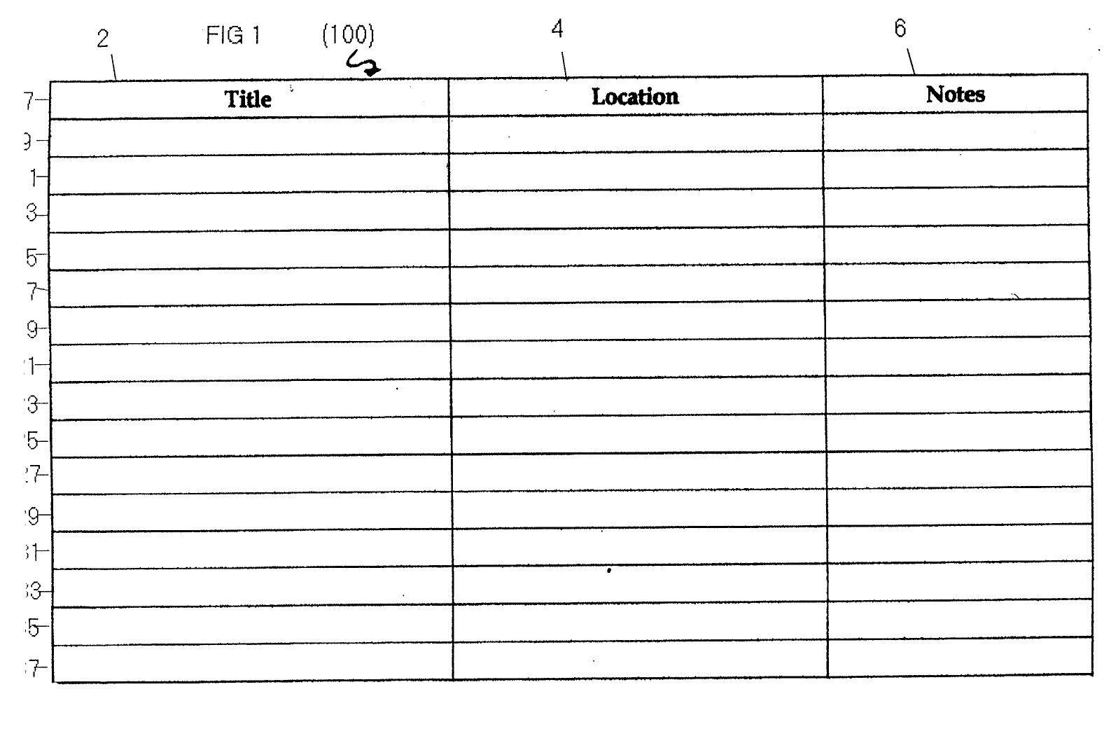

FIG. 1 shows a locator form (100) for use behind the appropriate tab-indexed divider (400) in the reference binder (700). The locator form allows the essential data for any particular recipe to be recorded in one central location, i.e., in the reference binder (700). The present invention is a significant improvement upon any existing methods because the locator form references many recipes of the same category at one time and on the same page. This allows the user a significant advantage when preparing a menu plan. The user does not have to page through numerous pages just to get an idea of what to make for a meal. Numerous recipes are recorded on one page in a clear, concise columnar format which is easy to read and easy to reference. The information required is limited to make the system easy to use and not cumbersome to complete as previous art may have required. The locator form may be, for example, approximately 5½ by 8½ inches in size made out of 20 lb. weight white paper in landscape orientation. The size, color, weight and orientation could vary. For example, the paper may be of heavier weight or in a larger format such as 8½ by 11 inches. Each locator form has three columns (2,4,6). The first row (7) of each column includes titles for each column. Alternatively, or in addition to, the last or any other row or rows may contain the titles of each column. The titles designate the type of information to be recorded in that column for each recipe. The titles may be preprinted, written in by the user or the like. Preferably, the titles are preprinted. Column (2) is entitled, “Title”, column (4) is entitled “Location”, and column (6) is entitled “Notes”. The titles of the columns may be in any order. A grid may be preprinted with multiple rows (7 . . . 37), for example, to allow the user to fill in the pertinent information. Each form is hole punched to allow it to be placed behind the appropriate tab indexed divider in the reference binder (700). The necessary data for each recipe may be contained in one row (9-37). The title of a particular recipe is found and other pertinent location information, such as, the page number of that source is recorded in that particular row in column (4). Notes regarding this particular recipe are recorded in the empty box in that particular row in column (6) i.e., for example, “Excellent”, “Mom's”, “Dinner Party”, “Dad likes”. The locator form may also include other columns.

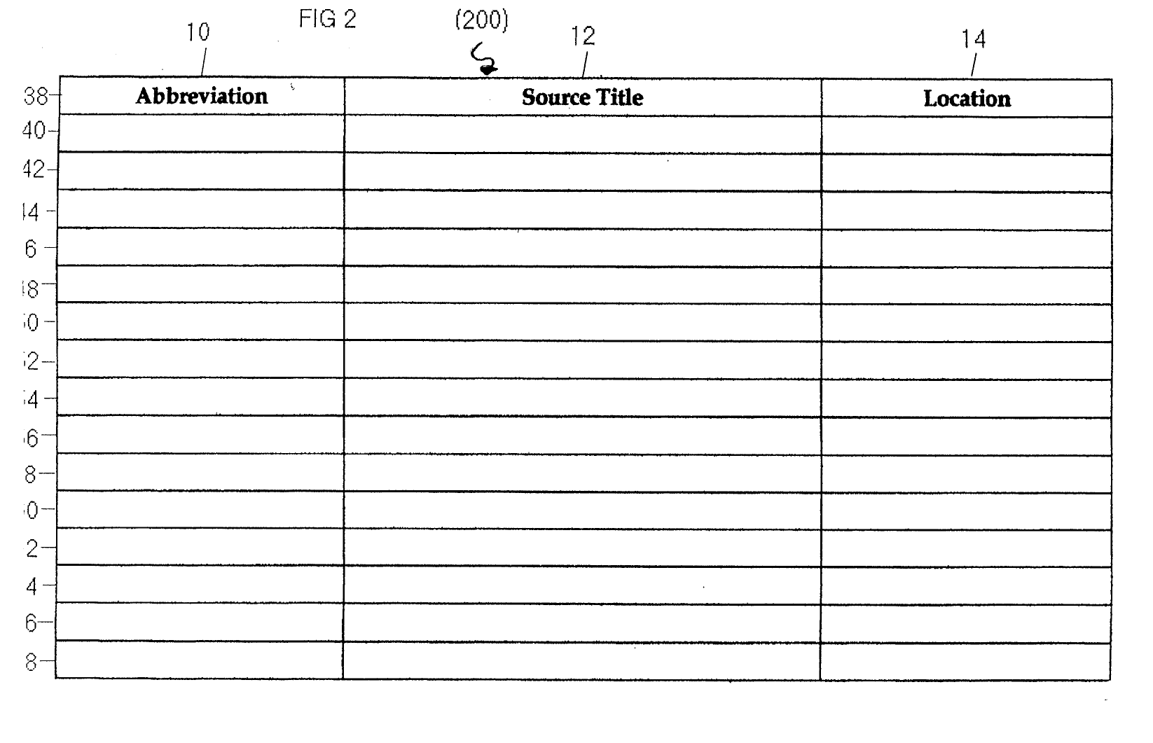

FIG. 2 shows a master index form (200) to list recipe sources. The master index form (200) is contained in the reference binder (700). The master index form (200) may be located in either the front or rear of the reference binder, i.e., either in front of or behind the appropriate tab indexed divider (400). The master index form, may be, for example, approximately 5½ by 8½ inches in size made out of 20 lb. weight white paper and in landscape orientation. The size, color, weight and orientation may vary. For example, the master index form may be a different color than other forms in the binder. Each master index form may have three columns (10,12,14). The first row (38) of each column includes the titles of each column. Alternatively or in addition the last or any other row or rows may contain the titles. The titles designate the type of information to be put in that column for each cookbook, or other recipe source. The titles may be preprinted, written in by a user, or the like. Preferably, the titles are preprinted. Column (10) is entitled, “Abbreviation”, column (12) is entitled, “Source Title” and column (14) is entitled “Location”. The titles of the columns may appear in any order right to left. A grid may be preprinted with multiple rows (38 . . . 68) and left blank to allow the user to fill in the pertinent information. Each form is hole punched to allow it to be placed behind the appropriate tab indexed divider in the reference binder (700). The necessary data for each cookbook or source is contained in one row (38 . . . 68). The title of the particular source is recorded in that particular row in column (12). The abbreviation for that particular source may be recorded in the empty box in that particular row in column (10). The location of where that particular source can be found may be recorded in that particular row (40-68) of column (14).

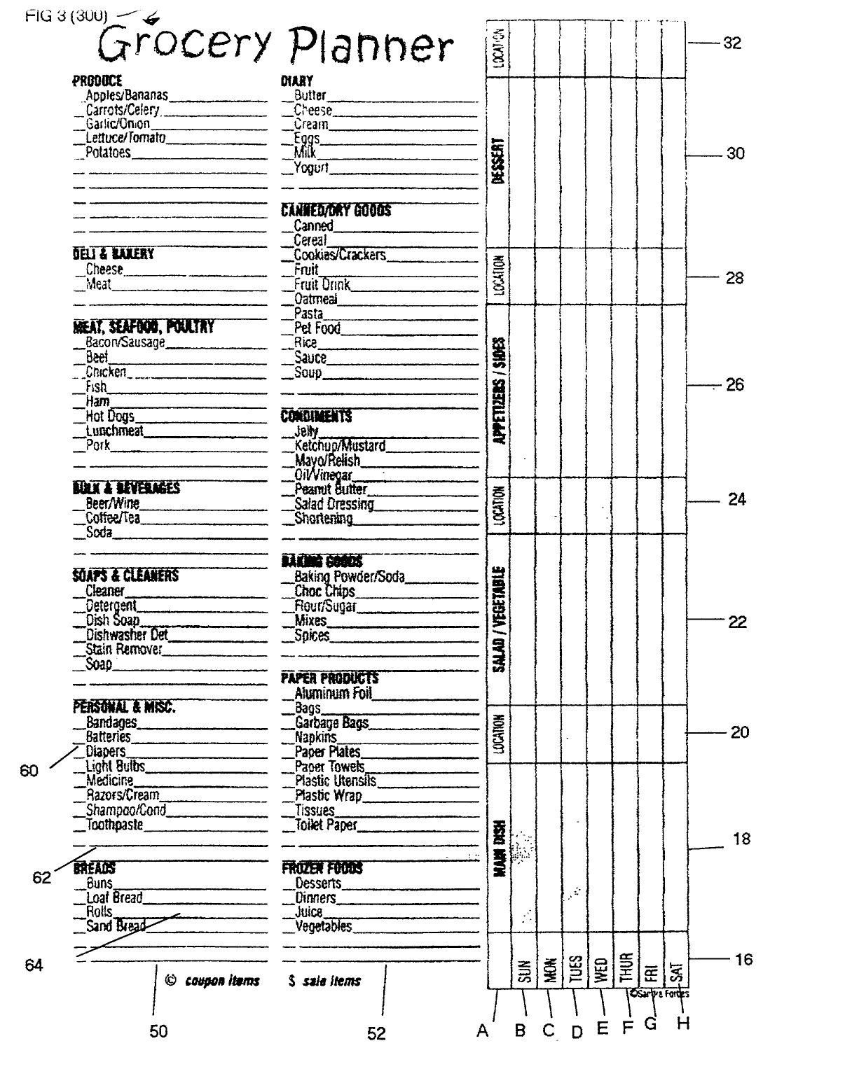

FIG. 3 shows a grocery planner form (300) where the names and locations of recipes chosen for future meals may be recorded and where needed grocery items can be recorded and referenced. The grocery planner form (300) may be, for example, approximately 5½ by 8½ inches in size made out of 20 lb. weight white paper and in portrait orientation. The size, color, weight and orientation could vary. The menu planner portion of the form has 9 columns (16,18,20,22,24,26,28,30,32) and 8 rows (A . . . H). For example, the first row (A) of each column may have preprinted titles for each column. Column (18) is entitled “Main Dish”, column (20) is entitled “Location”, column (22) is entitled “Salad/Vegetable”, column (24) is entitled “Location”, column (26) is entitled “Appetizers/Sides”, column (28) is entitled “Location”, column (30) is entitled “Dessert” and column (32) is entitled “Location”. Starting with row (B) in column (16) the days of the week are printed in consecutive rows. Although the days start with Sunday in the figure, any day of the week could be in row (B) with the consecutive days of the week following in consecutive rows. As shown, the days of the week are listed out in one set. Alternatively, any number of sets may be on one menu planner form. A grid may be preprinted to allow the user to fill in the appropriate information. Each form may be hole punched to allow it to be placed in the reference binder (700). The necessary data for a planned menu for a particular day is located in the appropriate row (B . . . H) for that day of the week. For example, the main entree planned for Sunday and the location of the recipe for that main entree planned for Sunday are recorded in the empty boxes of row (B) columns (18) and (20) respectively. The name of the Salad/Vegetable dish planned for Sunday and the location of the recipe are recorded in the empty boxes of row (B) columns (22) and (24) respectively. The name of the dessert planned for Sunday and the location of the recipe are recorded in the empty boxes of row (B) columns (30) and (32) respectively. The grocery list portion of the grocery planner form (300) is where popular food items are categorized according to how grocery stores commonly organize their aisles. Some of the categories that may be used are such as: Produce; Deli and Bakery; Meat,Seafood,Poultry; Bulk and Beverages; Soaps and Cleaners; Personal and Misc; Cereal and Canned Fruit; Paper Products; Baking Goods; Condiments; Dry Goods; Dairy; Frozen Foods; Breads. This portion is divided into two columns (50, 52), although any number of columns may be used. The grocery list portion of the grocery planner form (300) may be preprinted and/or include space for listing items. Popular food items are listed under each category with underscore lines before and/or following each item for further definition by the user. Any item can be selected for purchase by checking the blank space in front of the item (60). Instead of checking the blank space (60), a number can be written therein to indicate the number of items to be purchased. Further, the blank space (60) allows the user to indicate whether a coupon will be used with the purchase or whether the item is a sale item. Items not listed can be written in the extra spaces provided (62). The underscore following each item (64) allows the user to specify which type of the item he/she desires and further clarifies the purchasing need. Multiple grocery planner forms may be grouped together and adhered to one another to form a pad. This pad can be adhered to a surface such as a refrigerator and the forms may be used individually. A user can record needed grocery items all throughout the week and tear off one form at a time and take to the grocery store thus eliminating the need to rewrite a grocery list. It is a convenient way of keeping track of grocery items running low or that need to be replenished. The ability to have a menu plan refer to a recipe location distinguishes this method from other prior methods and is a significant improvement. This menu plan located on the same form as the grocery list is also a convenient and a significant improvement to prior methods. The blank spaces in front of and following each grocery item is an improvement of prior art giving the ability for the user to give greater definition to the grocery item in need. The categorizing of grocery items in combination with a listing of grocery items within that category is also an improvement upon prior art giving the user a tickler list to help remind the user of needed items.

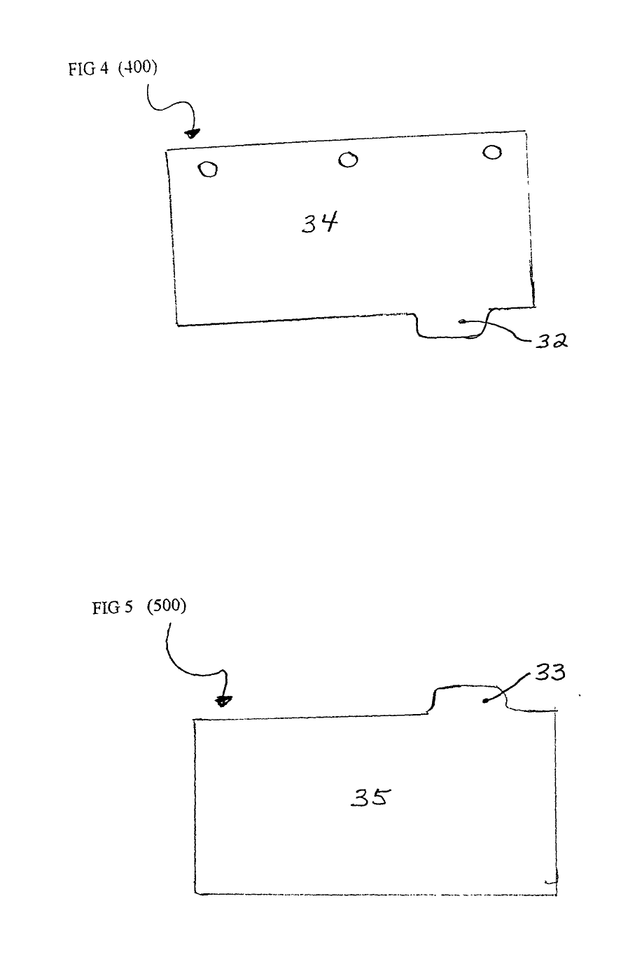

FIG. 4 shows a tab indexed divider (400) for the reference binder (700). The tab indexed dividers for the reference binder are step indexed to allow for a number of headings to be viewed simultaneously. Each tab (32) of each divider has one heading of a food category most often used in food preparation. The headings may be such as: Appetizers/Snacks; Dips/Spreads; Salads; Soups; Dressings/Sauces; Meatless; Beef; Pasta; Pork; Poultry; Seafood; Breakfast/Brunch; Vegetables/Sides; Desserts; Coffee Cakes/Quick Breads; Yeast Breads; Pies; Cookies/Bars; Cakes/Frostings; Candies; Beverages; Just for Kids. Previous inventions were limited to locating a specific recipe by its name or alphabetically based on an arbitrary categorizing of that recipe by the current user. The present invention standardizes the categories within the reference binder (700) and between system components thus making the system easy to use and keep up. Also, the user has the ability to customize the headings between components according to his/her own preferences and still have an effective system. The headings may be preprinted or the tabs may be blank allowing the user to input his own headings, thereby allowing customization. Each tab may be 1/2″ tall by 2″ wide, for example, and extend out from the body (34) which may be, for example, 8½″ by 5⅞″. Each tab extends from the body (34) on the opposite long side from where the holes are punched. Alternatively, or in addition to, the tabs may extend on either short side of the body (34) as well. The size and location of the tabs may vary. The size and composition of the divider may vary as well. Useful information may be preprinted on the body (34) of each divider and may relate to the category of that divider.

FIG. 5 shows the tab indexed divider (500) to be used in a user's recipe storage box. The tab indexed dividers for the storage box are step indexed to allow for a number of headings to be viewed simultaneously. Each tab (33) of each divider has one heading of a food category most often used in food preparation and relates to the headings used in the reference binder dividers (400). There may be more or fewer categories for storage box dividers (500) than reference binder dividers (400) because of subcategories but preferably the headings match. The headings may be preprinted or the tabs may be blank allowing the user to input his/her own headings, thereby allowing for customization. Each tab may be 3/4″ tall by 1⅞″ wide and extend out from the body (35) which may be 3¾″ high by 7¼″ wide. The size and location of the tabs may vary. The size and composition of the divider may vary as well. Useful information may be printed on the body (35) of each divider. This information may be related to the category of that divider. A series of labels may be preprinted with the same headings with the intent of adhering to previously used dividers. Having headings coordinate between the reference binder dividers (400) and the storage box dividers (500) is a significant improvement upon prior art. Having standardized headings between the system components creates a system easy to use and minimizes the amount of data that is required to be recorded to locate a given recipe.

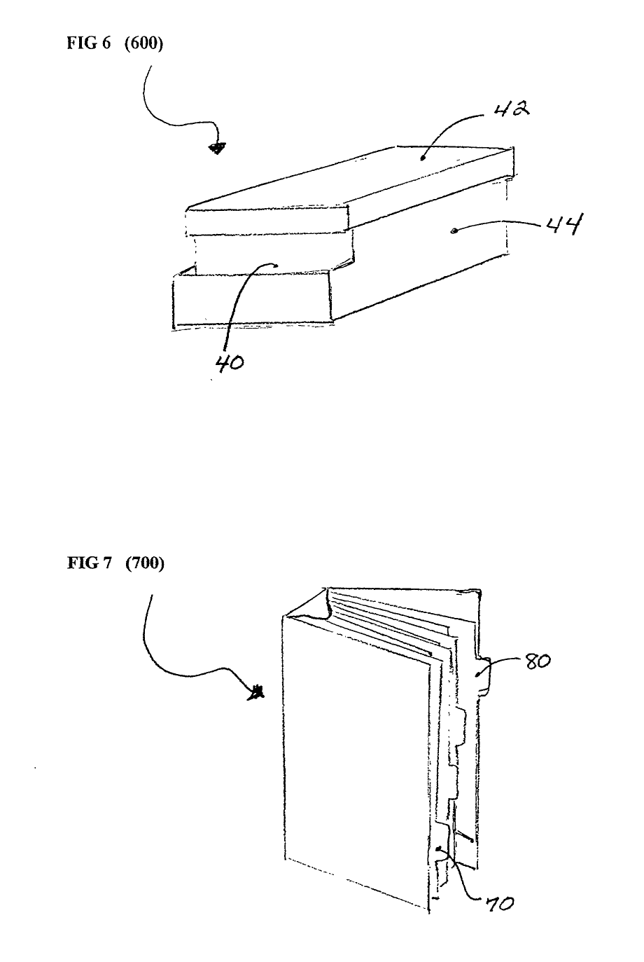

FIG. 6 is a three dimensional view of the storage box (600) where loose recipes are filed and stored. The dimensions of the box may be 11½″ by 7¾″ by 4¾″ which allows easy storage of various sized recipes. Also, a box of such size is easily and conveniently stored in a typical kitchen. The box has a lid (42) that separates from the body (44) of the box. The size and material from which the box is made can vary. A temporary storage compartment (40) where loose recipes may be stored extends out from the front of the box and can be easily accessed with the lid of the storage box closed. The temporary storage compartment (40) may be 7¾″ wide by 2½″ high and 1″ deep. The dimensions of this compartment may vary as well along with the size of the box. Alternatively, the storage compartment may be formed on the inside of the box and be located under the lid. In such an embodiment, the storage box can be formed by a wall within the box.

FIG. 7 shows a reference binder (700) where the location of recipes, the names and location of recipe sources and menu plans are indexed and recorded. The reference binder may be 7½″ by 9″ in size with a 1″ ring capacity. The size and ring capacity may vary. The reference binder is in a loose leaf format to allow for easy replacement of pages and reorganization. This is a significant improvement upon some previous art that doesn't allow for customization. The tab indexed dividers are placed in the binder in such a way so that many tabs are viewed simultaneously. The headings on the tabs of the tab indexed dividers indicate which divider the appropriate form should be filed behind. The tab indexed divider with the heading “Sources” (70) may be located toward the front of the reference binder and the before mentioned master index forms (200) can be filed behind it. The tab indexed divider with the heading “Menu Plans” (80) can be placed in the reference binder (700) and the before mentioned grocery planner forms (300) can be filed behind it. The tab indexed dividers with the headings of the food categories most often used in food preparation and any custom dividers can be placed in the reference binder (700). One or more locator forms (100) are then placed behind each divider. More locator forms (100) may be associated with the appropriate tab indexed divider as needed when the location of more recipes needs to be recorded. The capacity of the reference binder (700) can be easily enlarged by moving to a larger ring size.

The method of using the invention will now be described. Place the storage box tab indexed dividers into a storage box. Put the tab indexed dividers for the reference binder in the reference binder in the same order as that of the storage box with a locator form between each tab indexed divider. Place the master index form and corresponding divider in the reference binder. Go through all your recipe cards and loose recipes that have been tried and tested with approval and record the needed information on the appropriate locator form behind the appropriate tab indexed divider in the reference binder. Record the title of the recipe under “Title”, write “Recipe Box” under the “Location” column and record your personal rating or applicable notes under the “Notes” column. At the same time, file that recipe behind the corresponding tab indexed divider in your storage box. All remaining recipes can and should be filed in the appropriate section of your storage box for future reference when wanting to try a new recipe. A recipe is most commonly recorded at the time it has been tried for the first time but it may be recorded at any time. Once a recipe is indexed, it will never have to be recorded again. If that recipe meets with your approval then the appropriate information can be recorded on the locator form referring to the appropriate category for that recipe. When starting this system a user may choose to page through each cookbook he/she owns and one by one record each recipe he/she has tried and liked under the appropriate section of the reference binder or he/she may choose to wait and record that recipe the next time he/she uses that recipe. Either way the title of the dish is recorded under the “Title” column, write the cookbook name or abbreviation for that cookbook and the page number of where the recipe can be found under the “Location” column and record your personal rating or applicable notes under the “Notes” column. The titles of your cookbooks and all recipe sources may be abbreviated and recorded on the master index form and placed at the front of your reference binder for future reference.

To plan a weekly menu the user may want to sit down with his/her reference binder, family calendar, grocery planner and weekly sales advertisements from the local grocery store. Based on your family's schedule the user decides which nights the family has time to sit down to a meal and which nights may require a meal to be prepared ahead of time. Refer to the reference binder and the possible recipes under the various headings and decide what meals you will be making and record the title of that recipe and its location on your grocery planner. Each recipe can be easily located and the required ingredients be recorded on the grocery list portion of the grocery planner form. It takes a lot of stress away from meal preparation being able to come home and not have to wonder what's for dinner that night and whether you have the needed ingredients for that dinner. A running list should be kept on your grocery planner of any items that have been used up or are running low. Taking your grocery planner with you to the store will save you lots of time because of its conveniently organized format. After having picked up the groceries for that week the grocery planner form should be put in a convenient location so you can refer to your menu plan each day.

Although the invention has been described in terms of a recipe index apparatus and method, of course other types of articles or items could be indexed using the method of the present invention. For example, a user could store children's clothing in various containers. The containers may then have a simple identification thereon. The reference binder, and associated forms could then be used to record the contents and location of the containers. The multiple rows of the locator forms could be used to record the contents of the containers. As the contents of the containers change, i.e. size, seasons, type etc. a new form may be used thus eliminating the need to change the box identification every time the contents change. This allows the user to easily see the contents of each box without having to pull the box and look inside.

Also, although the method has been described as being carried out using a loose leaf type reference binder, a storage box and forms in hard copy, it could readily be implemented in software. That is, the various parts of the apparatus, for example the loose leaf reference binder, storage box and forms may be implemented by using a computer program which performs the same or similar functions as those described above. Instead of a storage box containing loose recipes, the recipes may be stored electronically in an electronic storage box.

What I claim as my invention is:

1. A method of providing a comprehensive system for recording, filing and indexing abstracted material from recipe sources for reference, comprising the steps of:
a) collecting a plurality of recipe sources
b) categorizing recipes by its use in a menu plan
c) providing an apparatus comprising of a storage box having a body, a lid and a series of tab-indexed dividers received therein labeled with categories corresponding to the series of tab-indexed dividers received within the binder
d) storing said categorized recipes that require storage into said storage box
e) providing an apparatus comprising of an information reference binder for storing
abstracted material from multiple sources in a single depository including
a plurality of categorized tab-indexed dividers received in the binder
a plurality of master index forms received within the binder and adjacent to said plurality of tab-indexed dividers
a plurality of locator forms received in the binder and adjacent to said plurality of tab-indexed dividers.
a plurality of menu planner forms received in the binder and adjacent to said plurality of tab-indexed dividers
f) recording the name of said recipe source in the master index received within the binder
g) recording said recipe name, location and applicable notes on said locator forms received within the binder
h) upon choosing a specific recipe to be included in a menu plan, recording said recipe name and location on said menu planner as referenced on the locator form in said reference binder.
